(19) United States
(12) Patent Application Publication
(10) Pub. No.: US 2026/0007990 A1
(43) Pub. Date: Jan. 8, 2026

(54) FILTER ELEMENT AND FILTER SYSTEM

(71) Applicant: MANN+HUMMEL GmbH, Ludwigsburg (DE)

(72) Inventor: Sören JURGENSON, Nordheim (DE)

(21) Appl. No.: 19/256,315

(22) Filed: Jul. 1, 2025

Related U.S. Application Data
(63) Continuation of application No. PCT/EP2023/084707, filed on Dec. 7, 2023.

(30) Foreign Application Priority Data
Jan. 9, 2023 (DE) 102023100329.1

(51) Int. Cl. B01D 35/30

(52) U.S. Cl. CPC B01D 35/30; B01D 2201/34; B01D 2201/4084

(57) ABSTRACT

A filter element for filtering fluid has a filter medium body with a seal circumferentially extending around the filter medium body for axially sealing when mounted as intended in a filter housing of a filter system. The seal has a first part of a connection device which secures in axial direction by form fit. The first part of the connection device corresponds to a second part of the connection device disposed at the filter housing. A filter system for filtering fluid includes the filter element exchangeably arranged in the filter housing. The filter housing has a circumferentially extending seal groove. The seal of the filter medium body is received in the seal groove when the filter element is mounted as intended in the filter housing. The seal groove has a second part of the connection device corresponding to the first part of the connection device at the seal.

### CROSS-REFERENCE TO RELATED APPLICATIONS

This application is a continuation application of international application No. PCT/EP2023/084707 having an international filing date of Dec. 7, 2023, and designating the United States, the international application claiming a priority date of Jan. 9, 2023, based on prior filed German patent application No. 10 2023 100 329.1, the entire contents of the aforesaid international application and the aforesaid German patent application being incorporated herein by reference.

### BACKGROUND

The invention concerns a filter element, for example a secondary element, for filtering a fluid, including at least one filter medium body, for example for use in an internal combustion engine or as interior air filter, for example of a motor vehicle, as well as a filter system with an exchangeable filter element.

Filter elements, for example filter elements employed as secondary elements or safety elements, seal the clean side in relation to the raw side of the filter system for example in case of exchanging the main filter element of a filter system. In this context, it is important that the secondary element, when opening the filter housing for exchange of the main filter element, stays with reliable sealing action at its installation site. After demounting the housing top part and the main filter element (secondary element and main filter element are arranged in general one atop the other), the secondary element stays in the sealed position and prevents damage to the motor.

Radially sealing interfaces for sealing the filter element in the filter housing are often used in filter elements, for example in case of flat filter elements used as secondary elements. In this context, a lattice arranged transversely to the flow direction supports the seal in radial direction. In case of large installation spaces, the lattice must be configured to be appropriately strong in order to be able to counteract the deformation but still provide the required seal-tightness.

DE 10 2016 006 607 A1 describes a filter system in which a free-foamed axial seal is used for sealing the filter system. The seal is designed such that in this context it is prevented that the seal in the installed state is pulled out of a corresponding housing-side seal chamber.

### SUMMARY

An object of the invention is to provide a filter element, for example a secondary element, for filtering a fluid which includes at least one filter medium body with a seal and which may be mounted easily and securely in a filter housing.

A further object is to provide a filter system including such a filter element which may be mounted easily and securely.

The aforementioned object is solved according to an aspect of the invention by a filter element, in particular secondary element, for filtering a fluid, including at least one filter medium body which includes a seal, extending circumferentially around an outer periphery of the filter medium body, for axially sealing when mounted as intended in an axial direction in a filter housing of a filter system, wherein the seal includes a part of a connection device, which secures substantially in axial direction by form fit, the part being configured to correspond to another part of the connection device at the filter housing.

The further object is solved according to a further aspect of the invention by a filter system for filtering a fluid, including a filter housing and at least one filter element, for example a secondary element, for filtering a fluid, which is exchangeably arranged in the filter housing between a raw side and a clean side and includes at least one filter medium body, wherein the filter housing includes a circumferentially extending seal groove in which, when the filter element is mounted as intended, a seal of the filter element is received, wherein the seal groove of the filter housing includes at least one part of a connection device, which secures substantially in axial direction by form fit, the part being configured to correspond to another part of the connection device at the at least one filter element, in particular wherein the connection device is configured as a snap-fit connection.

Beneficial embodiments and advantages of the invention result from the description, and the accompanying drawing figures.

A filter element, for example a secondary element, for filtering a fluid including at least one filter medium body is proposed which includes a seal surrounding an outer periphery of the filter medium body for axial sealing when mounted as intended in axial direction in a filter housing of a filter system. In this context, the seal includes a part of a connection device, which secures substantially in an axial direction by form fit, the part being configured so as to correspond to another part of the connection device at the filter housing.

Herein, “axial direction” is understood as a direction which is parallel to the main flow direction through the filter element.

Herein, “form fit” is understood such that the part of the connection device, which secures substantially in axial direction, is designed to fix, by interaction with the other part of the connection device provided at the filter housing, the filter element in relation to the filter housing relative to the axial direction by means of the direct transmission of holding forces, which extend in axial direction or at least include an axial component. This is in contrast to a frictional holding action according to which the exchange of the holding forces is normal to or perpendicular to the axial direction.

The seal-associated part of the connection device, securing substantially in axial direction by form fit, is configured in embodiments for example as one piece together with the seal, for example monolithic. The part of the connection device, securing substantially in axial direction by form fit, may be produced together with the seal in a forming process, for example by casting or injection molding.

The proposed filter element represents an air filter element which is used for example as a secondary element or safety element. In this context, the secondary element seals the clean side in relation to the raw side when exchanging the main filter element of a filter system. The secondary element stays with reliable sealing action at its installation site when opening the filter housing for exchanging the main filter element.

The filter medium body may include a cellulose-based and/or synthetic nonwoven medium and may be embodied as a filter element with a polyurethane seal (PUR seal) foamed directly onto the filter medium body.

In this context, the polyurethane seal in the proposed filter element is designed in such a way that it engages a housing interface or snaps in place thereat.

The filter element may be used for example in flat air filter elements in the field of commercial vehicles. The filter element includes an axial seal instead of a radial seal and enables a standardized housing contour in the region of the safety element as well as in the region of the main element. For example, an additional locking nose at the seal may engage the housing so that the filter element is held in its sealing position when exchanging the main element.

Disadvantages of radial seal concepts, which exhibit a high compression force and joining force due to a high friction by the pairing of the PUR foam with the housing, may be avoided by an axial seal. The same sealing contour may furthermore be used at the safety element as well as at the main element so that clear advantages for a standardization in regard to construction result.

According to an embodiment of the filter element, the part of the connection device at the seal may be configured as a part of a snap-fit connection. In this way, the filter element may be held at its sealing position when exchanging the main element.

According to an embodiment of the filter element, a plurality of snap-fit elements protruding at a slant, for example perpendicularly, in relation to the axial direction may be arranged at the seal. In particular, the snap-fit elements may be embodied as knobs projecting at a slant, for example perpendicularly, to the axial direction or as depressions. Knobs at the filter element and depressions at the filter housing may engage one another in a beneficial manner so that the filter element is held reliably at its place.

According to an embodiment of the filter element, the part of the connection device at the seal may be present at least at two opposed sides of the filter medium body. In this context, at least two snap-fit elements may be arranged for example at least at two opposed sides of the filter medium body. In this way, the filter element may be held at its sealing position when exchanging the main element.

According to an embodiment of the filter element, the part of the connection device at the seal may include an elevation, extending at a slant, for example perpendicularly, in relation to the axial direction and including an undercut which is configured for operative connection with the other part of the connection device at the filter housing. The other part of the connection device at the filter housing may include a rib projecting at a slant, for example perpendicularly, in relation to the axial direction, which may be received in the undercut beyond the elevation. With such a combination of the connection device at seal and filter housing, the filter element may also be held at its sealing position when exchanging the main element.

According to an embodiment of the filter element, the elevation may be embodied at least in sections so as to extend circumferentially on the outer periphery of the seal. The section-wise arrangement of the seal device may be sufficient to hold the filter element at its sealing position when exchanging the main element.

According to an embodiment of the filter element, the part of the connection device at the seal may include a groove which extends circumferentially at least in sections and is recessed in axial direction and which is configured for operative connection to the other part of the connection device at the filter housing. As an alternative, the part of the connection device at the seal may include a rib which extends circumferentially at least in sections and protrudes in axial direction away from the seal. With such a combination of the connection device at seal and filter housing, the filter element may also be held at its sealing position when exchanging the main element.

According to an embodiment of the filter element, the groove and/or the rib may include an undercut. In this manner, a particularly safe fixation of the filter element in its position may be achieved.

According to a further aspect of the invention, a filter system for filtering a fluid is proposed, including a filter housing and at least one filter element, for example a secondary element, for filtering a fluid, which is exchangeably arranged in the filter housing and includes at least one filter medium body. The filter housing includes a circumferentially extending seal groove in which, when the filter element is mounted as intended, the seal of the filter element is received. In this context, the seal groove of the filter housing includes at least one part of a connection device, which secures substantially in axial direction by form fit, the part being configured so as to correspond to another part of the connection device at the at least one filter element. In particular, the connection device may be embodied as a snap-fit connection.

The proposed filter system includes an air filter element which is used for example as a secondary element or safety element. In this context, the secondary element seals the clean side in relation to the raw side when exchanging the main filter element of the filter system. The secondary element stays with reliable sealing action at its installation site when opening the filter housing for exchanging the main filter element.

In this context, the polyurethane seal is embodied in such a way that it engages a housing interface or snaps in place thereat.

The filter system may be used for example in the field of commercial vehicles. The filter element includes an axial seal instead of a radial seal and enables a standardized housing contour in the region of the safety element as well as in the region of the main element. For example, an additional locking nose at the seal may engage the housing so that the filter element is held at its sealing position when exchanging the main element.

Disadvantages of radial seal concepts, which exhibit a high compression force and joining force due to a high friction by the pairing of the PUR foam with the housing, may be avoided by an axial seal. The same sealing contour may furthermore be used at the safety element as well as at the main element so that clear advantages for a standardization in regard to construction of the filter system result.

According to an embodiment of the filter system, the part of the connection device at the filter housing may include a plurality of snap-fit elements which protrude at a slant, for example perpendicularly, in relation to the axial direction and are configured for operative connection to the other part of the connection device at the filter element. In this way, the filter element may be held at its sealing position when exchanging the main element.

According to an embodiment of the filter system, the snap-fit elements may be configured as depressions or knobs projecting at a slant, for example perpendicularly, in relation to the axial direction. In this way, the filter element may be held in a beneficial manner at its sealing position when exchanging the main element.

According to an embodiment of the filter system, the part of the connection device at the filter housing may include a rib extending at a slant, for example perpendicularly, in relation to the axial direction, which is configured for operative connection to the other part of the connection device at the filter element. As an alternative, the part of the connection device may include an elevation, extending at a slant, for example perpendicularly, in relation to the axial direction and including an undercut. With such a combination of the connection device at the seal and filter housing, the filter element may also be held at its sealing position when exchanging the main element.

According to an embodiment of the filter system, the rib and/or the elevation may be embodied so as to extend circumferentially at least in sections. The arrangement of the seal device in sections may be sufficient to hold the filter element at its sealing position when exchanging the main element.

According to an embodiment of the filter system, the part of the connection device at the filter housing may include a rib which extends circumferentially at least in sections and projects in axial direction and which is configured for operative connection to the other part of the connection device at the filter element. As an alternative, the part of the connection device at the filter housing may include a groove which extends circumferentially at least in sections and is recessed in axial direction. In particular, corners of the sealing groove may be free of the connection device in this context. With such a combination of the connection device at seal and filter housing, the filter element may also be held at its sealing position when exchanging the main element.

According to an embodiment of the filter system, the rib and/or the groove may include an undercut. In this manner, a particularly safe fixation of the filter element in its position may be achieved.

### BRIEF DESCRIPTION OF DRAWINGS

Further advantages result from the following description of the drawings. Embodiments of the invention are illustrated in the drawings. The drawings and the following detailed description of embodiments contain numerous features in combination. A person of skill in the art will consider the features expediently also individually and combine them to further expedient combinations.

FIG. 1 shows an exploded illustration of a filter system according to an embodiment of the invention.

FIG. 2 shows an enlarged detail of the illustration of FIG. 1 with parts of a connection device of a filter element and a filter housing.

FIG. 3 shows a detail of a cross section through the filter system according to FIG. 1.

FIG. 4 shows an enlarged detail of the illustration of FIG. 3 with parts of the connection device of the filter element and the filter housing.

FIG. 5 shows an isometric illustration of the filter element of the filter system according to FIG. 1.

FIG. 6 shows an enlarged detail of parts of a connection device of a filter element and a filter housing according to a further embodiment of the invention.

FIG. 7 shows an isometric illustration of a housing bottom part for receiving a filter element according to a further embodiment of the invention.

FIG. 8 shows an isometric illustration of the filter element corresponding to the housing bottom part according to FIG. 7.

FIG. 9 shows an enlarged detail of a cross section through the filter element according to FIG. 8 in the region of the seal.

FIG. 10 shows an enlarged detail of a cross section through a seal groove of the housing bottom part for receiving the seal according to FIG. 9.

FIG. 11 shows an enlarged plan view of the housing bottom part in the region of a corner of the seal groove.

FIG. 12 shows an enlarged detail of a cross section through the seal groove of the housing bottom part according to FIG. 10 with an inserted filter element.

FIG. 13 shows a detail of a cross section through a filter system according to a further embodiment of the invention.

FIG. 14 shows an enlarged detail of a cross section through the filter element according to FIG. 13 in the region of the seal.

FIG. 15 shows an enlarged detail of a cross section through the housing bottom part according to FIG. 13 in the region of the seal groove.

FIG. 16 shows an enlarged plan view of the housing bottom part in the region of a corner of the seal groove according to the embodiment according to FIG. 15.

FIG. 17 shows a plan view of the housing bottom part according to the embodiment according to FIG. 15.

FIG. 18 shows an enlarged detail of a cross section through a housing bottom part in the region of the seal groove according to a further embodiment of the invention.

FIG. 19 shows an enlarged detail of a cross section through a filter element in the region of the seal according to the embodiment according to FIG. 18.

### DETAILED DESCRIPTION

In the drawing figures, the same or same-type components are identified with same reference characters. The drawing figures show only examples and are not to be understood as limiting.

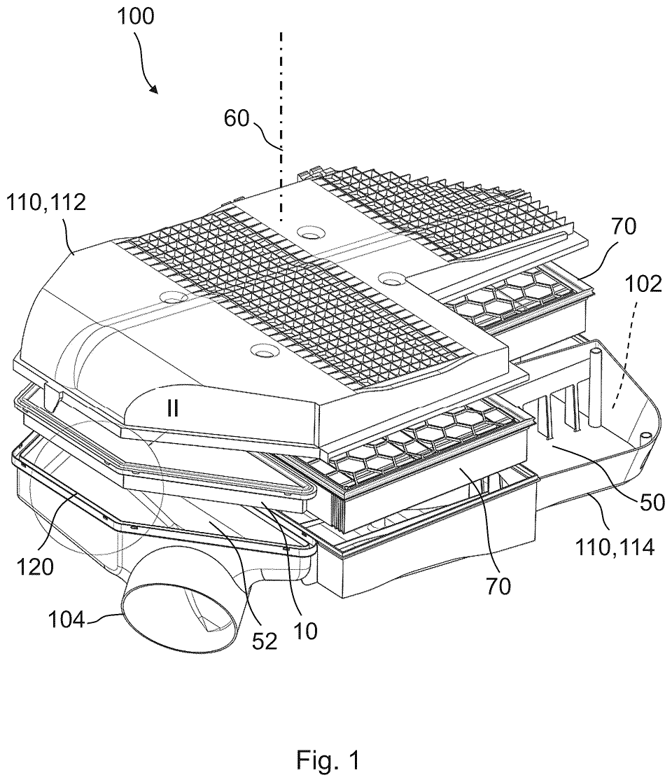

FIG. 1 shows an exploded illustration of a filter system 100 according to an embodiment of the invention.

The filter system 100 comprises a filter housing 110 with a housing top part 112 and a housing bottom part 114. The housing bottom part 114 comprises an inlet 102 and an outlet 104 for the fluid to be filtered.

Two main filter elements 70 are arranged in the filter housing 110 and, in flow direction downstream thereof, a filter element 10 as a secondary element or safety element. The main filter elements 70 are arranged between the raw side 50 and the clean side 52 of the filter system 100. The filter element 10 is arranged at the clean side 52 and remains at its installation position when exchanging the main filter elements 70. In this way, the downstream fluid tract and, for example, a motor are protected from contamination during filter change. The filter element 10 may also be exchanged.

The fluid flow to be filtered enters the filter housing 110 through the inlet 102. The main filter elements 70 are flowed through in the drawing from the bottom to the top. The fluid flows at the top side of the main filter elements 70 to the secondary element 10. The secondary element 10 is flowed through from the top to the bottom until the fluid flow exits again through the outlet 104 from the filter housing 110.

The filter element 10 comprises a filter medium body 12 which, for example, is formed of cellulose and/or a nonwoven filter medium. The filter medium may be folded, for example.

The filter medium body 12 comprises a seal 14 circumferentially extending on an outer periphery 13 of the filter medium body 12 for axial sealing when installed as intended in an axial direction 60 in a filter housing 110 of a filter system 100. The seal 14 comprises a part of a connection device 20, securing substantially in axial direction 60 by form fit, the part being configured embodied corresponding to another part of the connection device 20 at the filter housing 110.

For receiving the filter element 10, the filter housing 110 comprises a circumferentially extending seal groove 120 in which the seal 14 of the filter element 10 is received when the filter element 10 is mounted as intended.

The seal groove 120 of the filter housing 110 comprises the other part of the connection device 20. The connection device 20 is formed for example as a snap-fit connection.

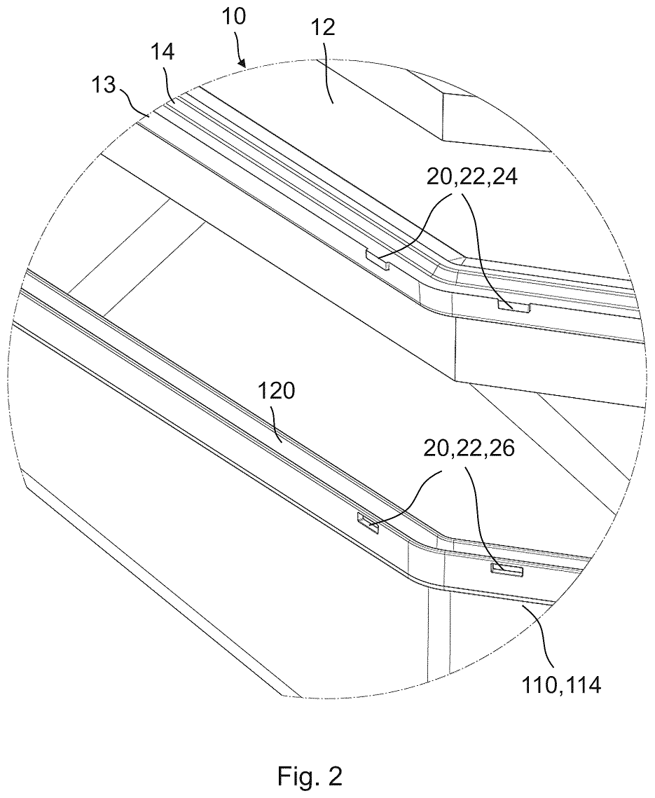

FIG. 2 provides in this context an enlarged detail of the illustration of FIG. 1 with parts of the connection device 20 of filter element 10 and filter housing 110.

The part of the connection device 20 at the seal 14 of the filter element 10 is formed as a part of the snap-fit connection. For this purpose. a plurality of snap-fit elements 22 protruding at a slant, for example perpendicularly, in relation to the axial direction 60 are provided at the seal 14. In the illustrated embodiment, the snap-fit elements 22 are designed as knobs 24 projecting at a slant, for example perpendicularly, in relation to the axial direction 60.

The part of the connection device 20 at the filter housing 110 comprises a plurality of snap-fit elements 22 protruding at a slant, for example perpendicularly, in relation to the axial direction 60 and configured for operative connection to the other part of the connection device 20 at the filter element 10. These snap-fit elements 22 in the illustrated embodiment are designed as depressions 26 extending at a slant, for example perpendicularly, in relation to the axial direction 60.

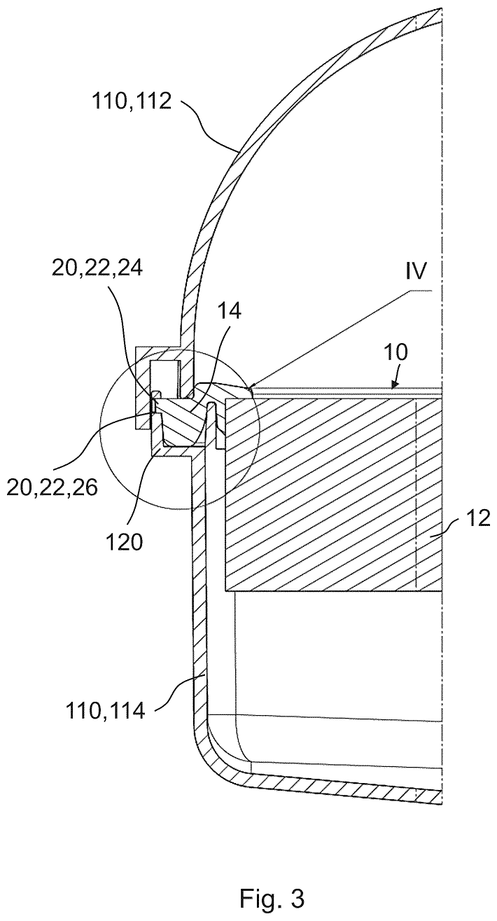

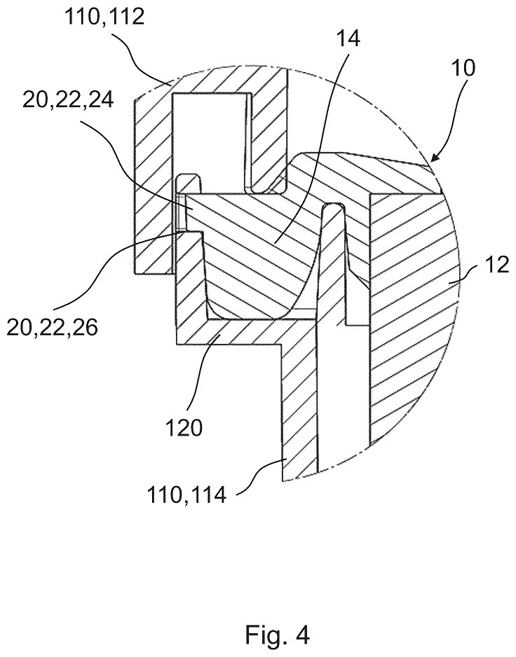

FIG. 3 shows a detail of a cross section through the filter system 100 according to FIG. 1. In FIG. 4, an enlarged detail of the illustration of FIG. 3 with parts of the connection device 20 of filter element 10 and filter housing 110 may be seen.

In particular, in cross section it may be seen how the knobs 24 of the seal 14 engage the depressions 26 or cutouts of the seal groove 120 of the housing bottom part 114. When inserting the filter element 10 into the housing bottom part 114, the knobs 24 snap into the depressions 26 of the seal groove 120 and in this manner lock the filter element 10 in the housing bottom part 114. In this manner, the filter element 10 is secured against accidental removal from the housing bottom part 114; this is important for example when the housing is opened during exchange of at least one of the main filter elements 70.

The seal 14 engages around an edge of the filter medium body 12 because the seal 14, made, for example, of polyurethane (PUR), is foamed onto the filter medium body 12. The seal 14 is received in regard to its cross section in the seal groove 120. When the filter housing 110 is closed, a seal edge of the housing top part 112 is resting on the seal 14, compresses the seal 14 in the seal groove 120, and effects thus an axial sealing action of the filter element 10 in axial direction 60 against the outlet 104 of the filter housing 110.

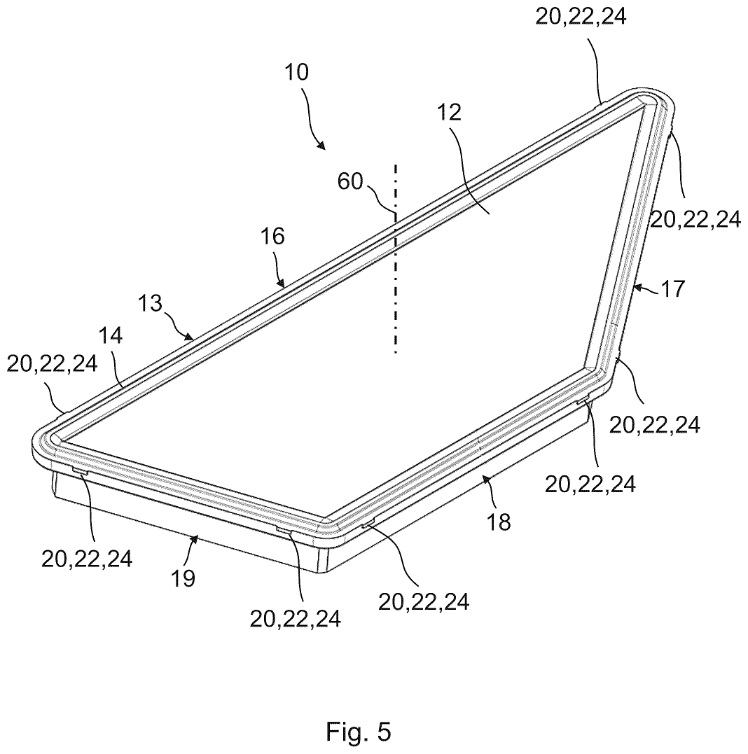

FIG. 5 shows an isometric illustration of the filter element 10. The part of the connection device 20 at the seal 14 is beneficially positioned at least at two opposed sides 16, 18; 17, 19 of the filter medium body 12. In the embodiment illustrated in FIG. 5, snap-fit elements 22 are arranged at all longitudinal sides 16, 18; 17, 19 of the filter medium body 12 in order to achieve a secure locking action of the filter element 10 in the seal groove 120 of the housing bottom part 114.

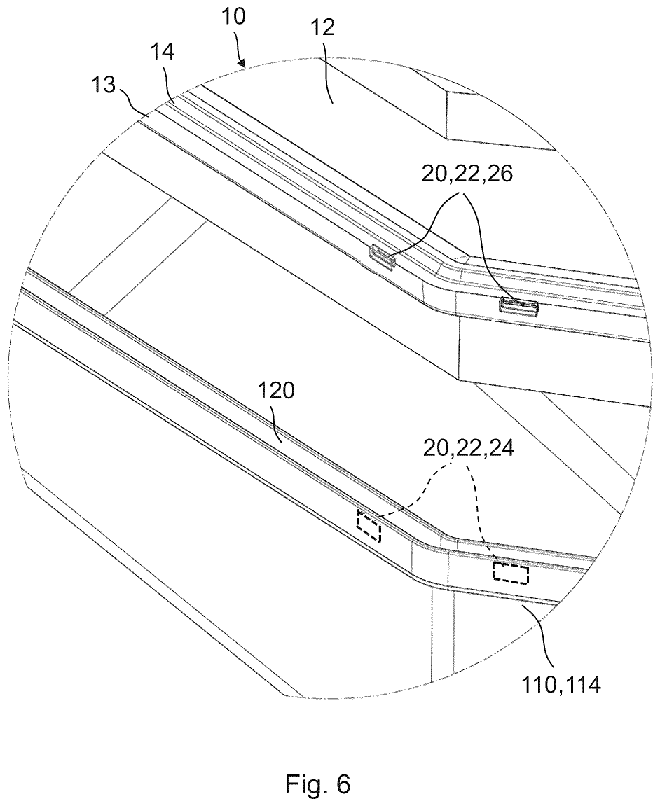

FIG. 6 shows an enlarged detail of parts of a connection device 20 of filter element 10 and filter housing 110 according to a further embodiment of the invention.

In this embodiment, knobs 24 as snap-fit elements 22 of the connection device 20 are arranged in the seal groove 120 while the seal 14 comprises depressions 26 as corresponding snap-fit elements 22. In this manner, a safe locking action of the filter element 10 in the seal groove 120 of the housing bottom part 114 may also be achieved.

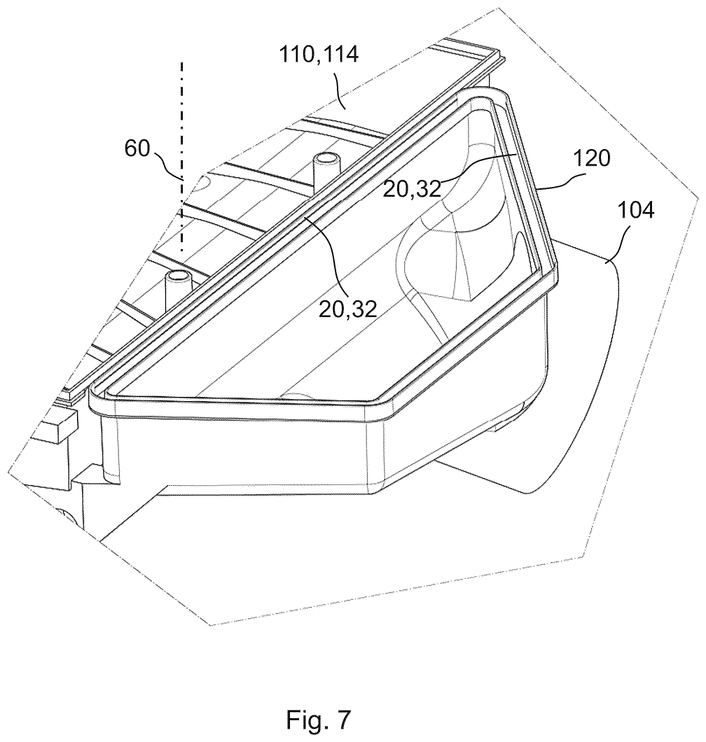

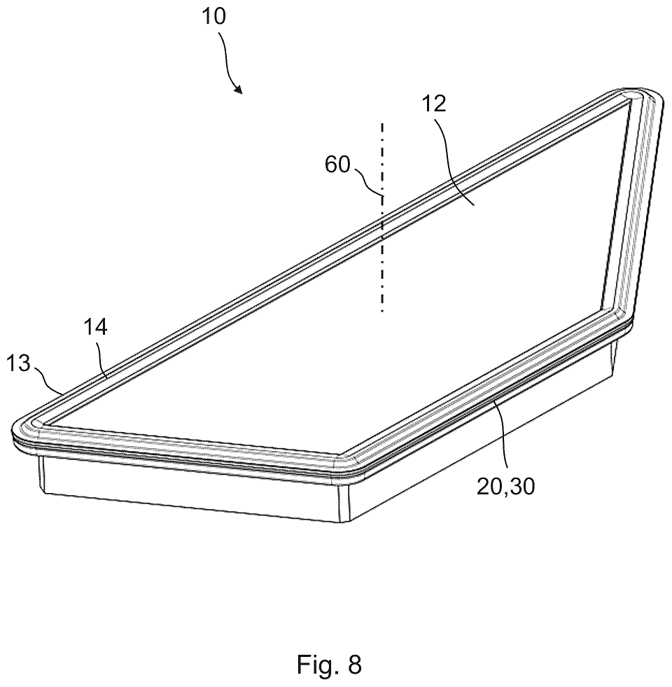

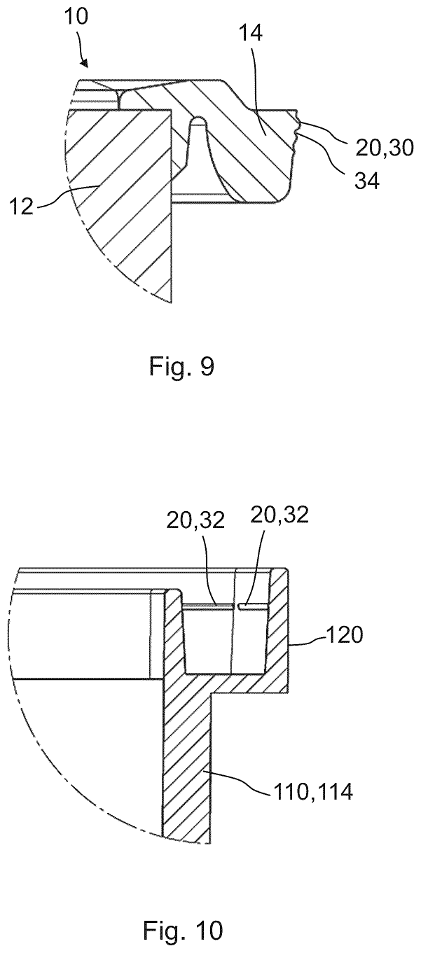

FIG. 7 shows an isometric illustration of the housing bottom part 114 for receiving the filter element 10 according to a further embodiment of the invention, while in FIG. 8 an isometric illustration of the filter element 10 corresponding therewith is illustrated. FIG. 9 shows in this context an enlarged detail of a cross section through the filter element 10 according to FIG. 8 in the region of the seal 14 and FIG. 10 an enlarged detail of a cross section through the seal groove 120 of the housing bottom part 114 for receiving the seal 14 according to FIG. 9.

In this embodiment, the part of the connection device 20 at the seal 14 comprises an elevation 30, extending at a slant, for example perpendicularly, in relation to the axial direction 60 and comprising an undercut 34 which is configured for operative connection to the other part of the connection device 20 at the filter housing 110. The part of the connection device 20 at the filter housing 110 comprises for this purpose a rib 32 extending at a slant, for example perpendicularly, in relation to the axial direction 60. When inserting the filter element 10 into the housing bottom part 114, the rib 32 snaps across the elevation 30 of the seal 14 into the undercut 34 so that the seal 14 locks at the rib 32. In this way, the filter element 10 is locked with the seal 14 in the seal groove 120 of the housing bottom part 114 and cannot slide accidentally out of the seal seat.

It is sufficient when the elevation 30 of the seal 14 is formed at least in sections so as to extend circumferentially on the outer periphery 13; likewise, in order to achieve a sufficient fixation of the filter element 10 in the housing bottom part 114, the rib 32 at the seal groove 120 of the housing bottom part 114 may be formed so as to extend circumferentially only in sections.

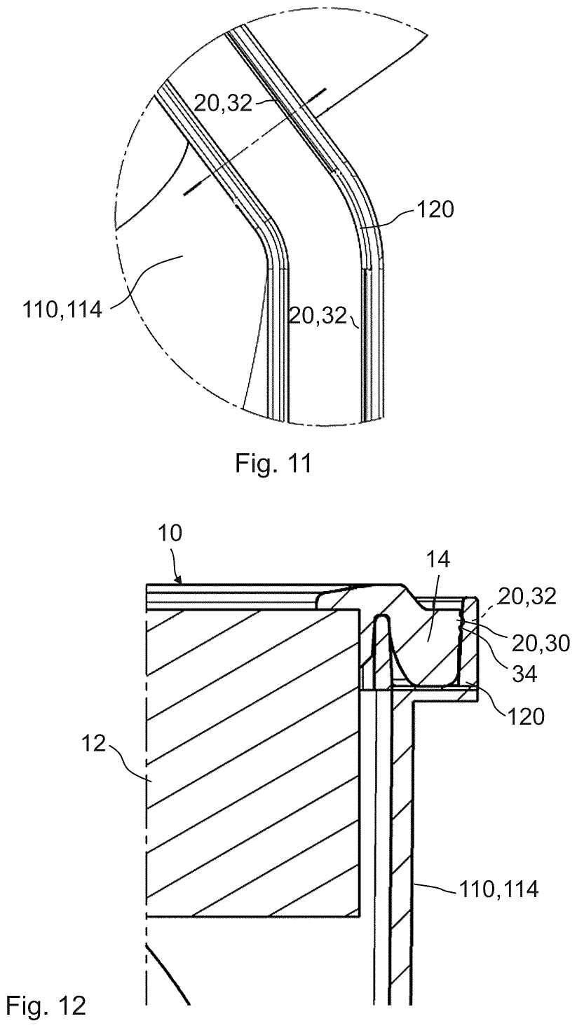

FIG. 11 shows an enlarged plan view of the housing bottom part 114 in the region of a corner of the seal groove 120 where it may be seen that the rib 32 is cut out in the region of the corner of the seal groove 120. In this manner, the manufacture of the housing bottom part 114 may be facilitated based on the required removal upon injection molding.

In FIG. 12, an enlarged detail of a cross section through the seal groove 120 of the housing bottom part 114 according to FIG. 10 is illustrated with inserted filter element 10. The rib 32 of the seal groove 120 has penetrated into the undercut 34 of the elevation 30 of the seal 14 and therefore cannot be seen anymore. Thus, the seal 14 is locked in the seal groove 120 and the filter element 10 securely fixed in the housing bottom part 114 in this way.

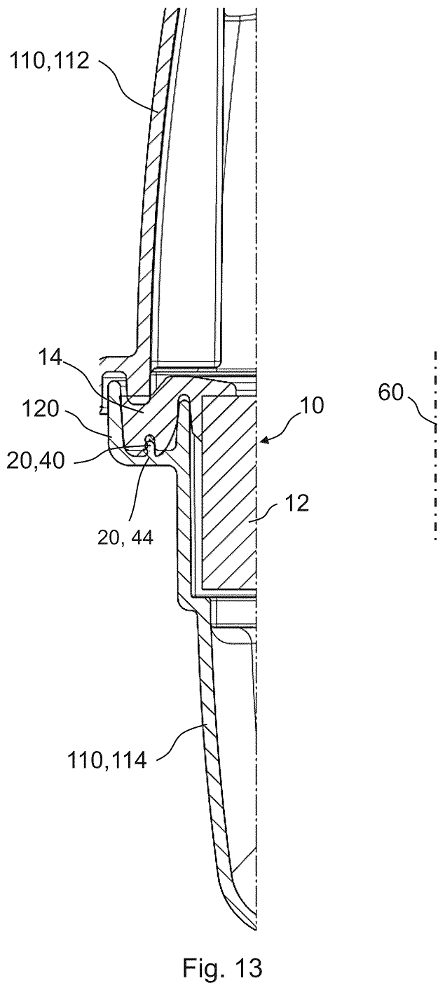

FIG. 13 shows a detail of a cross section through a filter system 100 according to a further embodiment of the invention.

In this embodiment, the part of the connection device 20 at the seal 14 comprises a groove 40 which extends circumferentially at least in sections and is recessed in axial direction 60 and which is configured for operative connection with the other part of the connection device 20 at the filter housing 110. The part of the connection device 20 at the filter housing 110 comprises for this purpose a rib 44 which extends circumferentially at least in sections and projects in axial direction 60. When inserting the filter element 10 with its seal 14 into the seal groove 120, the rib 44 of the seal groove 120 engages the groove 40 of the seal 14 so that the seal 14 is locked in the seal groove 120.

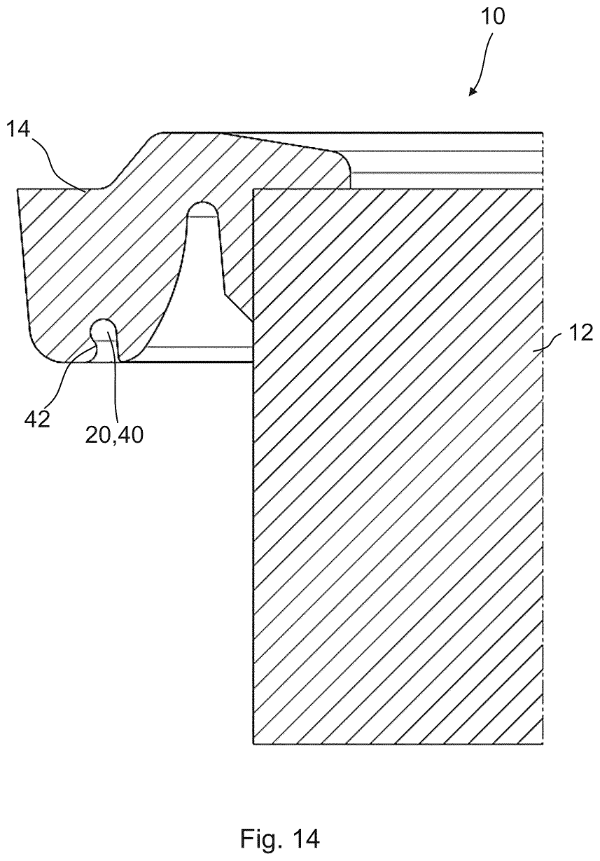

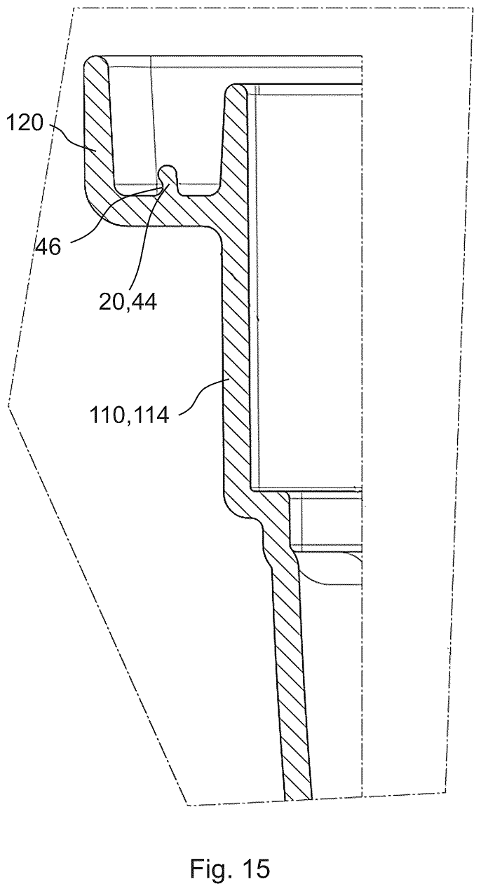

FIG. 14 shows an enlarged detail of a cross section through the filter element 10 according to FIG. 13 in the region of the seal 14, while in FIG. 15 an enlarged detail of a cross section through the housing bottom part 114 according to FIG. 13 in the region of the seal groove 120 is illustrated.

In the Figures it may be seen that the groove 40 comprises an undercut 42 and the rib 44 also comprises an undercut 46. Due to the two undercuts 42, 46, the rib 44 may lock in the groove 40 when joining rib 44 and groove 40 so that the seal 14 and thus the filter element 10 are fixed in the seal groove 120.

Here it is also sufficient for fixing the seal 14 of the filter element 10 when the rib 44 in the seal groove 120 is formed so as to extend circumferentially only in sections.

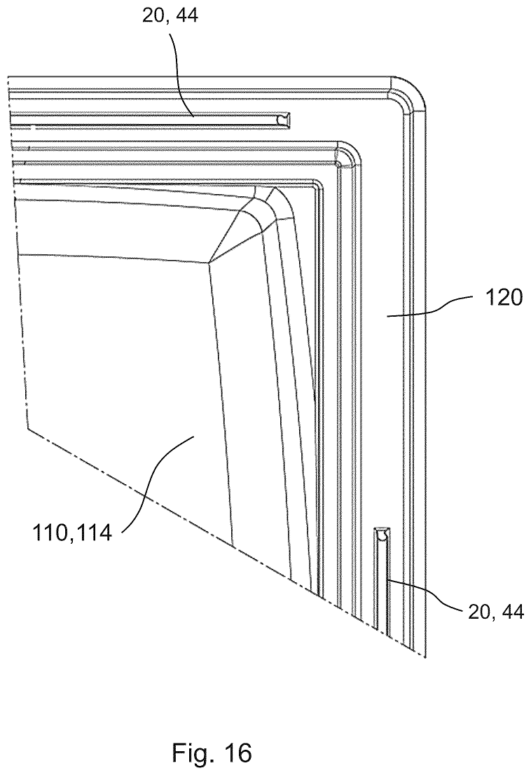

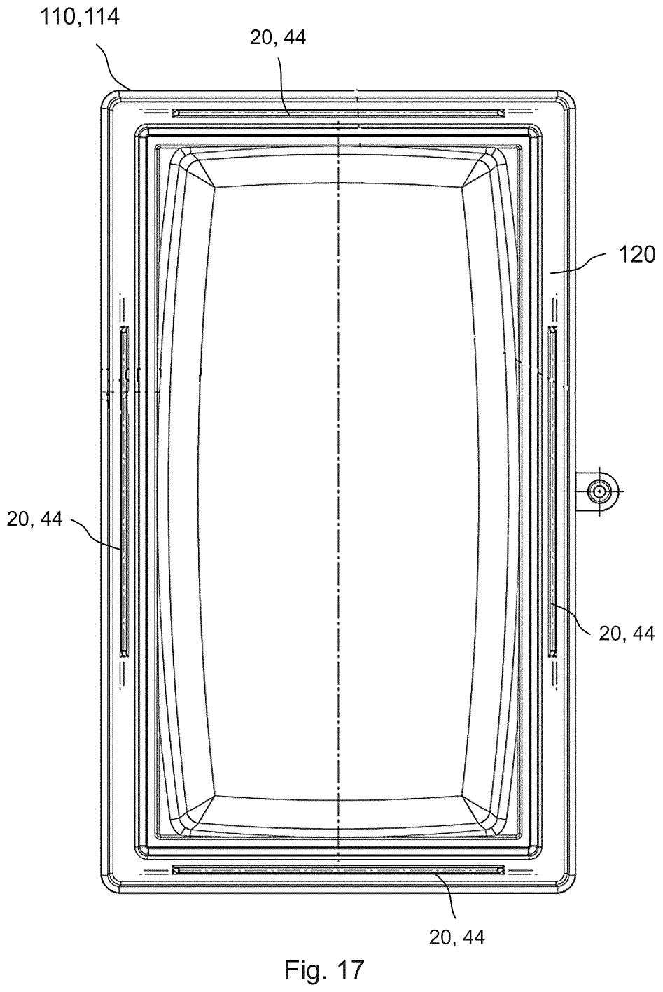

FIG. 16 shows in this context an enlarged plan view of the housing bottom part 114 in the region of a corner of the seal groove 120 according to the embodiment according to FIG. 15 while, FIG. 17 shows a plan view of the housing bottom part 114 with the receptacle for the entire filter element 10. The filter element 10 in this embodiment is formed in a rectangular shape in contrast to the preceding embodiments. In the FIG. 16 and the FIG. 17 it may be seen that for example the corners of the seal groove 120 are not provided with the rib 44. In this manner, the manufacture of the housing bottom part 114 may be facilitated based on the required removal upon injection molding.

In an alternative embodiment, the part of the connection device 20 at the seal 14 may comprise a rib 44 which extends circumferentially at least in sections and projects in axial direction 60 away from the seal 14 while the part of the connection device 20 at the filter housing 110 comprises a groove 40 which extends circumferentially at least in sections and is recessed in axial direction 60. In this context, when inserting the filter element 10 with the seal 14 into the seal groove 120, the rib 44 of the seal 14 may engage the groove 40 of the seal groove 120 and the seal 14 may lock in the seal groove 120 in this manner. In this way, the filter element 10 may be fixed in the housing bottom part 114. In particular, in this context corners of the seal groove 120 may also remain free of the connection device 20 so that the manufacture of the housing bottom part 114 is facilitated based on the required removal upon injection molding.

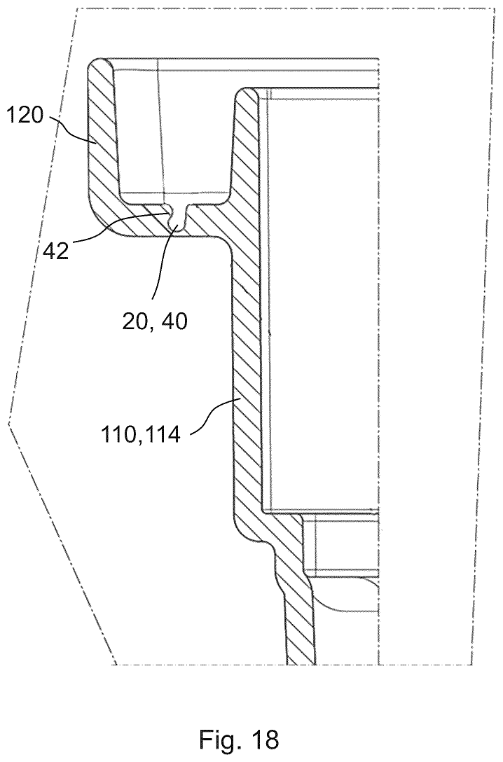

FIG. 18 shows in this context an enlarged detail of a cross section through a housing bottom part 114 in the region of the seal groove 120 in which the groove 40 may be seen in the seal groove 120.

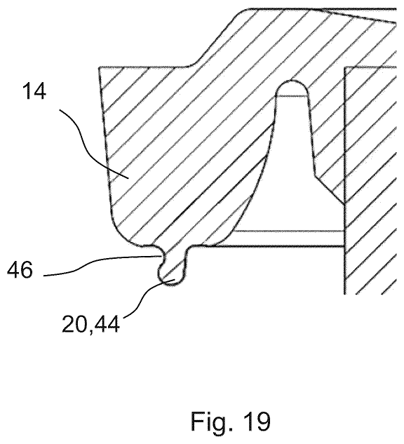

In FIG. 19 an enlarged detail of a cross section through the filter element 10 in the region of the seal 14 is illustrated which enables a view of the rib 44, corresponding to the groove 40, in the seal 14.

### REFERENCE CHARACTERS

10 filter element
12 filter medium body
13 periphery
14 seal
16 side
17 side
18 side
19 side
20 connection device
22 snap-fit element
24 knobs
26 depression
30 elevation
32 rib
34 undercut
40 groove
42 undercut
44 rib
46 undercut
50 raw side
52 clean side
60 axial direction
70 main element
100 filter system
102 inlet
104 outlet
110 filter housing
112 housing top part
114 housing bottom part
120 seal groove

What is claimed is:

1. A filter element for filtering a fluid, the filter element comprising:
at least one filter medium body comprising a seal circumferentially extending around an outer periphery of the at least one filter medium body and configured to axially seal when mounted in an axial direction in a filter housing;
wherein the seal comprises a first part of a connection device, configured to secure in an axial direction by form fit, wherein the first part of the connection device is configured to correspond to a second part of the connection device disposed at the filter housing.

2. The filter element according to claim 1, wherein the first part of the connection device and the seal are monolithic.

3. The filter element according to claim 2, wherein the first part of the connection device and the seal are a cast part or an injection-molded part.

4. The filter element according to claim 1, wherein the first part of the connection device directly transmits holding forces in the axial direction in an operative contact with the second part of the connection device.

5. The filter element according to claim 1, wherein the first part of the connection device comprises snap-fit elements protruding at a slant in relation to the axial direction.

6. The filter element according to claim 5, wherein the snap-fit elements are knobs projecting at a slant in relation to the axial direction or the snap-fit elements are depressions extending at a slant in relation to the axial direction.

7. The filter element according to claim 1, wherein the first part of the connection device is present at least at two opposed sides of the at least one filter medium body.

8. The filter element according to claim 1, wherein the first part of the connection device comprises an elevation extending at a slant in relation to the axial direction and comprising an undercut, wherein the undercut is configured for operative connection to the second part of the connection device.

9. The filter element according to claim 8, wherein the undercut is configured to receive a rib of the second part of the connection device, the rib projecting at a slant in relation to the axial direction.

10. The filter element according to claim 1, wherein the first part of the connection device comprises a groove extending circumferentially at least in sections around the seal and being recessed in the axial direction, wherein the groove is configured for operative connection to the second part of the connection device, and wherein the groove comprises an undercut.

11. The filter element according to claim 1, wherein the first part of the connection device comprises a rib extending circumferentially at least in sections around the seal and projecting in the axial direction away from the seal, and wherein the rib comprises an undercut.

12. A filter system for filtering a fluid, the filter system comprising:
a filter housing;
the filter element according to claim 1, exchangeably arranged in the filter housing;
wherein the filter housing comprises a circumferentially extending seal groove;
wherein the seal of the at least one filter medium body of the filter element is received in the circumferentially extending seal groove of the filter housing when the filter element is mounted in the filter housing;
wherein the circumferentially extending seal groove of the filter housing comprises a second part of the connection device, securing in the axial direction by form fit, wherein the second part of the connection device corresponds to the first part of the connection device at the seal of the at least one filter medium body of the filter element.

13. The filter system according to claim 12, wherein the connection device is a snap-fit connection, and wherein the second part of the connection device comprises snap-fit elements protruding at a slant in relation to the axial direction and configured for operative connection to the first part of the connection device.

14. The filter system according to claim 13, wherein the snap-fit elements are depressions extending at a slanted in relation to the axial direction or knobs projecting at a slanted in relation to the axial direction.

15. The filter system according to claim 12, wherein the second part of the connection device comprises a rib extending at a slant to the axial direction and configured for operative connection to the first part of the connection device at the seal of the at least one filter medium body of the filter element.

16. The filter system according to claim 12, wherein the second part of the connection device comprises an elevation extending at slant in relation to the axial direction and comprising an undercut.

17. The filter system according to claim 12, wherein the second part of the connection device comprises a rib extending circumferentially at least in sections around the circumferentially extending seal groove of the filter housing and projecting in the axial direction, wherein the rib is configured for operative connection to the first part of the connection device at the seal of the at least one filter medium body of the filter element.

18. The filter system according to claim 12, wherein the second part of the connection device comprises a groove extending circumferentially at least in sections around the circumferentially extending seal groove of the filter housing and being recessed in the axial direction.

19. The filter system according to claim 18, wherein corners of the circumferentially extending seal groove are free of the of the groove of the second part of the connection device.

20. The filter system according to claim 18, wherein the groove of the second part of the connection device comprises an undercut.
